(19) United States
(12) Patent Application Publication
(10) Pub. No.: US 2019/0141193 A1
(43) Pub. Date: May 9, 2019

(54) METHOD, SYSTEM, AND NON-TRANSITORY COMPUTER READABLE MEDIUM FOR SELECTING OPTIMAL NETWORK PATH FOR MEDIA TRANSMISSION IN VoIP

(71) Applicant: LINE Corporation, Tokyo (JP)

(72) Inventor: Sang-Hyun LEE, Seongnam-si (KR)

(73) Assignee: LINE Corporation, Tokyo (JP)

(21) Appl. No.: 16/157,558

(22) Filed: Oct. 11, 2018

(30) Foreign Application Priority Data
Nov. 6, 2017 (KR) 10-2017-0146803

(51) Int. Cl. H04M 7/00; H04L 29/06; H04L 12/26

(52) U.S. Cl. CPC H04M 7/0063; H04L 65/80; H04L 65/608; H04L 43/0864; H04L 65/1003; H04L 43/0829; H04L 65/1069

(57) ABSTRACT

A method of selecting an improved and/or optimal network path for media transmission in a voice over Internet protocol (VoIP) includes generating a media channel candidate capable of performing a media transmission between users in a VoIP; setting one of the media channel candidates as a temporary media channel and estimating a network performance; and changing the temporary media channel with a current media channel based on a result of estimating the network performance. The estimating and the changing is sequentially iterated with respect to each of media channels corresponding to the media channel candidates.

### CROSS-REFERENCE TO RELATED APPLICATION(S)

This U.S. non-provisional application claims the benefit of priority under 35 U.S.C. § 119 to Korean Patent Application No. 10-2017-0146803 filed on Nov. 6, 2017, in the Korean Intellectual Property Office (KIPO), the entire contents of which are incorporated herein by reference.

### BACKGROUND

### Field

One or more example embodiments relate to a technique for selecting an improved and/or optimal network path for media transmission in a voice over Internet protocol (VoIP).

### Description of Related Art

In general, voice over Internet protocol (VoIP) systems consist of encoding the voice of a user to a digital data packet and transmitting the digital data packet over an Internet protocol (IP) network.

Additionally, IP networks may add various types of data services, for example, file transmission, e-mails, and instant messaging, as well as audio such as voice, and may transmit a media packet such as a video, a photo, and music.

### SUMMARY

One or more example embodiments provide a technique that may select an improved and/or optimal network path for media transmission between users in a voice over Internet protocol (VoIP).

One or more example embodiments also provide a network path selection technique that may decrease and/or minimize network overhead of a client.

One or more example embodiments also provide a network path selection technique that may decrease and/or minimize a network change effect of a client over time.

According to an aspect of at least one example embodiment, there is provided a method implemented by a computer system. The method includes generating, by one or more processors of the computer system, a plurality of media channel candidate capable of performing a media transmission between users in a voice over Internet protocol (VoIP) communication session, setting, by the one or more processors, one of the plurality of media channel candidates as a temporary media channel, estimating, by the one or more processors, network performance of the temporary media channel, changing, by the one or more processors, a current media channel of the VoIP communication session to the temporary media channel based on a result of estimating the network performance of the temporary media channel, and the estimating and the changing is sequentially iterated with respect to each a plurality of media channels corresponding to the plurality of media channel candidates.

The generating may include generating the plurality of media channel candidates by combining an address list of a plurality of media relay servers capable of performing the media transmission.

The generating may include generating the plurality of media channel candidates by further including at least one of peer-to-peer (P2P) media service and a 3^{rd} party cloud service using the media relay server.

The estimating may include simultaneously estimating the network performance of the temporary media channel and comparing the network performance of the temporary media channel to network performance of the current media channel.

The estimating may include transmitting a probe packet through the temporary media channel, and calculating at least one network metric using a response to the probe packet, the at least one network metric including at least one of a round trip time (RTT), a delay variance, a packet loss, and a bandwidth.

The calculating the at least one network metric may include applying a different weight to each of the at least one network metric based on at least one of a media stream type and a network environment.

The estimating may include adjusting a network performance estimation order for the plurality of media channel candidates based on location information of at least one of a user requesting communication and a user responding to the communication request, and history information of a media channel previously selected between the users.

The method may further include initially using, by the one or more processors, a primary media channel set as a default, as the media channel for the media transmission prior to the generating. The primary media channel may be maintained in response to changing the primary media channel to the temporary media channel.

According to an aspect of at least one example embodiment, there is provided a non-transitory computer-readable medium storing computer readable instructions that, when executed by at least one processor, cause the at least one processor to perform the method.

According to an aspect of at least one example embodiment, there is provided a computer system including one or more processors configured to execute non-transitory computer-readable instructions included in a memory. The one or more processors are configured to generate a plurality of media channel candidates capable of performing a media transmission between users in a voice over Internet protocol (VoIP) communication session, set one of the plurality of media channel candidates as a temporary media channel, estimate network performance of the temporary media channel, and change a current media channel of the VoIP communication session to the temporary media channel based on a result of the estimating the network performance of the temporary media channel, and the estimating and the changing are sequentially iterated with respect to each of a plurality of media channels corresponding to the plurality of media channel candidates.

Further areas of applicability will become apparent from the description provided herein. The description and specific examples in this summary are intended for purposes of illustration only and are not intended to limit the scope of the present disclosure.

### BRIEF DESCRIPTION OF THE FIGURES

Example embodiments will be described in more detail with regard to the figures, wherein like reference numerals refer to like parts throughout the various figures unless otherwise specified, and wherein:

FIG. 1 is a diagram illustrating an example of a network environment according to at least one example embodiment;

FIG. 2 is a block diagram illustrating a configuration of an electronic device and a server according to at least one example embodiment;

FIG. 3 is a block diagram illustrating an example of a component includable in a processor of a server according to at least one example embodiment;

FIG. 4 is a flowchart illustrating an example of a method performed by a server according to at least one example embodiment;

FIG. 5 illustrates an example of a procedure of searching for an improved and/or optimal network path for media transmission according to at least one example embodiment;

FIG. 6 illustrates an example of a media channel search process according to at least one example embodiment;

FIGS. 7 through 9 illustrate examples of a process of calculating a network metric according to at least one example embodiment; and

FIG. 10 illustrates an example of a media channel candidate according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be iterated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products.

Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes specially programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device), and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be illustrated as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors, distributed processors, cloud processing systems, etc.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

A network path selection method according to one or more example embodiments may be performed through a computer system such as an electronic device and/or a server to be described below. Here, a computer program according to at least one example embodiment may be installed and executed on the computer system and the computer system may perform the network path selection method according to at least one example embodiment under control of the executed computer program. The computer program may be stored in non-transitory computer-readable media to execute the network path selection method on a computer in conjunction with the computer system. For example, the server may serve as a voice over Internet protocol (VoIP) server and a global VoIP service may select an improved and/or optimal server among a large number of media relay servers distributed globally to exchange media packets between users. Depending on the example embodiment, the electronic device may select the improved and/or optimal network path.

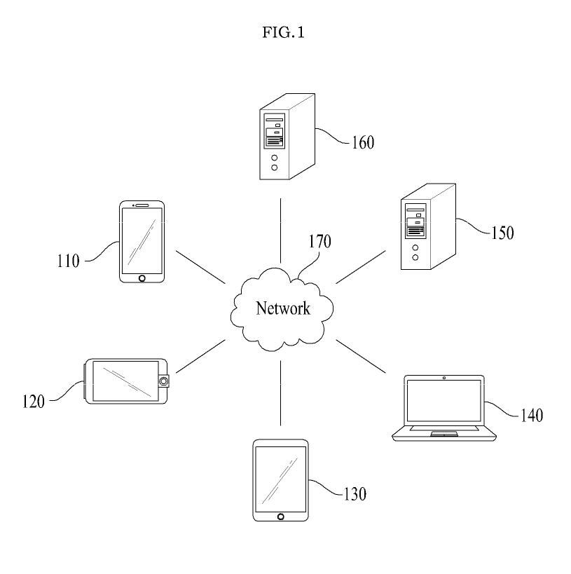

FIG. 1 is a diagram illustrating an example of a network environment according to at least one example embodiment. Referring to FIG. 1, the network environment includes a plurality of electronic devices 110, 120, 130, and 140, a plurality of servers 150 and 160, and a network 170, but the example embodiments are not limited thereto. FIG. 1 is provided as an example only and thus, the number of electronic devices and/or the number of servers are not limited thereto.

Each of the plurality of electronic devices 110, 120, 130, and 140 may be a fixed terminal or a mobile terminal configured as a computer device. For example, the plurality of electronic devices 110, 120, 130, and 140 may be a smartphone, a mobile phone, a personal navigation device, a computer, a laptop computer, a digital broadcasting terminal, a personal digital assistant (PDA), a portable multimedia player (PMP), a tablet personal computer (PC), a game console, a wearable device, an Internet of things (IoT) device, a virtual reality (VR) device, an augmented reality (AR) device, and the like. For example, although FIG. 1 illustrates the electronic device 110 in the shape of a smartphone, but it is provided as an example only. Here, the electronic device 110 may refer to any type of various physical computer systems capable of communicating with other electronic devices 120, 130, and/or 140, and/or the servers 150 and/or 160 over the network 170 in a wired communication manner and/or in a wireless communication manner.

The communication scheme is not particularly limited and may include a communication method that uses a near field communication between devices as well as a communication method using a communication network, for example, a mobile communication network, the wired Internet, the wireless Internet, a broadcasting network, a satellite network, etc., which may be included in the network 170. For example, the network 170 may include at least one of network topologies that include networks, for example, a personal area network (PAN), a local area network (LAN), a campus area network (CAN), a metropolitan area network (MAN), a wide area network (WAN), a broadband network (BBN), the Internet, and the like. Also, the network 170 may include at least one of network topologies that include a bus network, a star network, a ring network, a mesh network, a star-bus network, a tree or hierarchical network, and the like. However, it is only an example and the example embodiments are not limited thereto.

Each of the servers 150 and 160 may be configured as a computer apparatus or a plurality of computer apparatuses that provides computer readable instructions, codes, files, contents, services, and the like through communication with the plurality of electronic devices 110, 120, 130, and/or 140 over the network 170. For example, the server 150 may be a system that provides at least one first service to the plurality of electronic devices 110, 120, 130, and/or 140 connected over the network 170. The server 160 may be a system that provides at least one second service to the plurality of electronic devices 110, 120, 130, and/or 140 connected over the network 170. In detail, the server 150 may provide, as the first service, at least one service (e.g., a voice over Internet protocol (VoIP) service, video chat service, etc.) intended by a corresponding application through the application as the computer program that is installed and executed on the plurality of electronic devices, such as electronic devices 110, 120, 130, and/or 140, etc. As another example, the server 160 may provide, as the second service, at least one service that distributes a file for installing and executing the application to the plurality of electronic devices, such as electronic devices 110, 120, 130, and/or 140, etc.

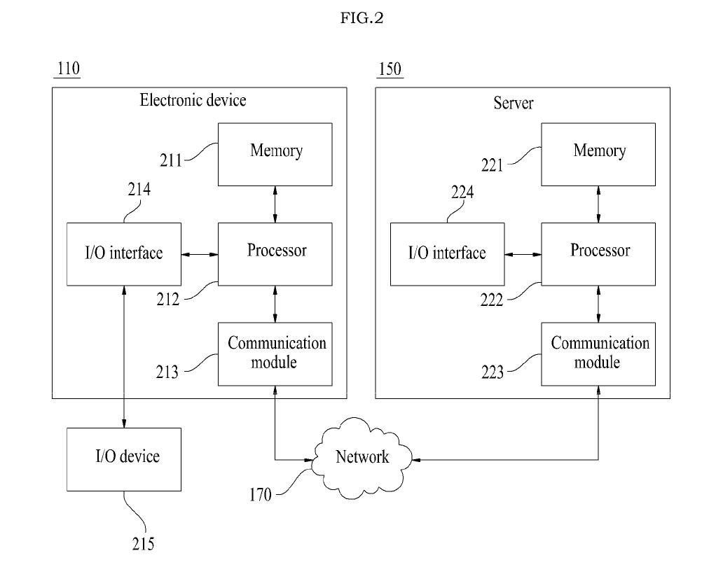

FIG. 2 is a block diagram illustrating an example of a configuration of an electronic device and a server according to at least one example embodiment. FIG. 2 illustrates a configuration of the electronic device 110 as an example for a single electronic device and illustrates a configuration of the server 150 as an example for a single server. The same or similar components may be applicable to other electronic devices 120, 130, and/or 140, or the server 160, and also to still other electronic devices or still other servers.

Referring to FIG. 2, the electronic device 110 may include a memory 211, at least one processor 212, a communication module 213, and/or an input/output (I/O) interface 214, but is not limited thereto. The server 150 may include a memory 221, at least one processor 222, a communication module 223, and/or an I/O interface 224, but is not limited thereto. The memory 211, 221 may include a permanent mass storage device, such as random access memory (RAM), read only memory (ROM), a disk drive, a solid state drive (SSD), a flash memory, etc., as a non-transitory computer-readable medium. Here, the permanent mass storage device, such as ROM, SSD, flash memory, disk drive, etc., may be included in the electronic device 110 and/or the server 150 as a permanent storage device separate from the memory 211, 221. Also, an OS or at least one program code, for example, a code for an application for providing a specific service installed on the electronic device 110 and/or a browser installed and executed on the electronic device 110, may be stored in the memory 211, 221. Such software components may be loaded from another non-transitory computer-readable medium separate from the memory 211, 221 using a drive mechanism. The other non-transitory computer-readable medium may include, for example, a floppy drive, a disk, a tape, a Blu-ray/DVD/CD-ROM drive, a memory card, etc. According to other example embodiments, software components may be loaded to the memory 211, 221 through the communication module 213, 223, instead of, or in addition to, the non-transitory computer-readable medium. For example, at least one program may be loaded to the memory 211, 221 based on a computer program, for example, the application, installed by files provided over the network 170 from developers or a file distribution system, for example, the server 160, which provides an installation file of the application.

The processor 212, 222 may be configured to process computer-readable instructions of a computer program by performing basic arithmetic operations, logic operations, and I/O operations. The computer-readable instructions may be provided from the memory 211, 221 and/or the communication module 213, 223 to the processor 212, 222. For example, the processor 212, 222 may be configured to execute received instructions in response to the program code stored in the storage device, such as the memory 211, 222.

The communication module 213, 223 may provide a function for communication between the electronic device 110 and the server 150 over the network 170, and may provide a function for communication between the electronic device 110 and/or the server 150 and another electronic device, for example, the electronic device 120 or another server, for example, the server 160. For example, the processor 212 of the electronic device 110 may transfer a request created based on a program code stored in the storage device such as the memory 211, to the server 150 over the network 170 under control of the communication module 213. Inversely, a control signal, an instruction, content, a file, etc., provided under control of the processor 222 of the server 150 may be received at the electronic device 110 through the communication module 213 of the electronic device 110 by going through the communication module 223 and the network 170. For example, a control signal, an instruction, content, a file, etc., of the server 150 received through the communication module 213 may be transferred to the processor 212 or the memory 211, and content, a file, etc., may be stored in a storage medium, for example, the permanent storage device, further includable in the electronic device 110.

The I/O interface 214 may be a device used for interface with an I/O device 215. For example, an input device may include a device, such as a keyboard, a mouse, a microphone, a camera, etc., and an output device may include a device, such as a display, a speaker, a haptic feedback device, etc. As another example, the I/O interface 214 may be a device for interface with an apparatus in which an input function and an output function are integrated into a single function, such as a touchscreen. The I/O device 215 may be configured as a single device with the electronic device 110. Also, the I/O interface 224 of the server 150 may be a device used for connection with the server 150 or for interface with a device (not shown) for input or output includable in the server 150. In detail, when processing instructions of the computer program loaded to the memory 211, the processor 212 of the electronic device 110 may display a service screen configured using data provided from the server 150 or the electronic device 120, or may display content on a display through the I/O interface 214.

According to other example embodiments, the electronic device 110 and the server 150 may include a greater or lesser number of components than a number of components shown in FIG. 2. For example, the electronic device 110 may include at least a portion of the I/O device 215, or may further include other components, for example, a transceiver, a global positioning system (GPS) module, a camera, a variety of sensors, a database, and the like. In detail, if the electronic device 110 is a smartphone, the electronic device 110 may be configured to further include a variety of components, for example, an accelerometer sensor, a gyro sensor, a camera module, various physical buttons, a button using a touch panel, an I/O port, a haptic feedback motor for vibration, etc., which are generally included in the smartphone.

Hereinafter, example embodiments of a system and method for selecting an improved and/or optimal network path for media transmission in VoIP will be described.

To find an improved and/or optimal media channel for media transmission between users, there is a need to enhance the quality of service (QoS) and to reduce the overhead (e.g., the amount of processing power and/or memory resources consumed, etc.) for estimating and comparing quality of media channels. Also, influence over the media currently being transmitted needs to be insignificant. In addition, a media channel selection operation may not delay generation of a media channel for a channel connection and a temporary degradation in quality of an access network may not cause an erroneous channel change.

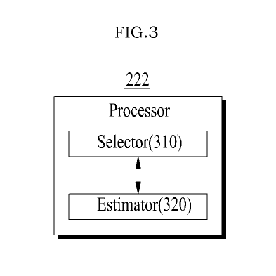

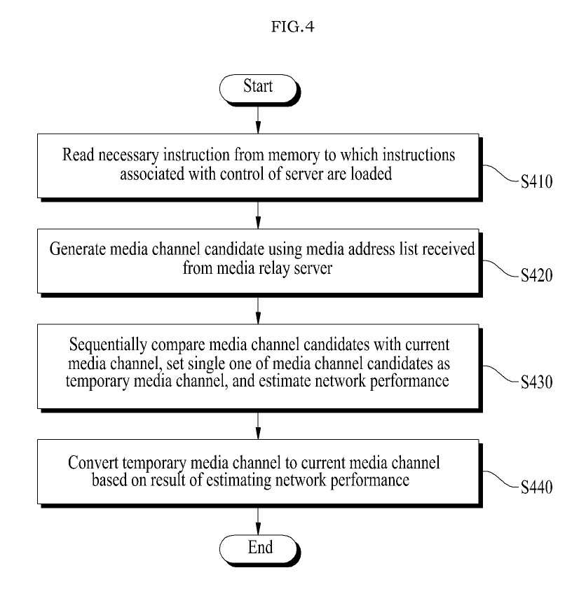

FIG. 3 is a block diagram illustrating an example of a component includable in at least one processor of a server according to at least one example embodiment, and FIG. 4 is a flowchart illustrating an example of a method performed by a server according to at least one example embodiment.

The server 150 according to some of the example embodiment serves as a platform that provides a global VoIP service to the plurality of electronic devices 110, 120, 130, and/or 140, etc., that are clients. The server 150 may provide a VoIP service in conjunction with an application installed on each of the electronic devices 110, 120, 130, and/or 140, etc., and may transmit at least one media packet between users by finding an improved and/or optimal media channel in the VoIP service.

Referring to FIG. 3, to perform the network path selection method of FIG. 4, the server 150 may include a selector 310 and an estimator 320 as components of the processor 222 of the server 150. Depending on example embodiments, the components of the processor 222 may be selectively included in or excluded from the processor 222. Also, depending on the example embodiments, the components of the processor 222 may be separate or merged for representation of a function of the processor 222.

The processor and the components of the processor 222 may control the server 150 to perform operations 5410 through 5440 included in the network path selection method of FIG. 4. For example, the processor 222 and the components of the processor 222 may be configured to execute computer readable instructions according to a code of at least one program and a code of an OS included in the memory 221.

Here, the components of the processor 222 may be representations of different functions of the processor 222 performed by the processor 222 in response to computer readable instructions provided from a program code stored in the server 150. For example, the selector 310 may be used as a functional representation of the processor 222 that controls the server 150 to select an improved and/or optimal media channel for media transmission.

Referring to FIG. 4, in operation S410, the processor 222 may read a necessary computer readable instruction from the memory 221 to which computer readable instructions associated with control of the server 150 are loaded. In this case, the read computer readable instruction may include a computer readable instruction for controlling the processor 222 to perform operations S420 through S440.

In operation S420, the selector 310 may generate a media channel candidate using a media address list received from at least one media relay server over a global network. Here, the media relay server relates to at least one network element (e.g., a network device, such as a server, gateway, workstation, router, switch, interface, etc.) that connects a VoIP communication session between at least two electronic devices and processes at least one media stream, for example, a round trip protocol/RTP control protocol (RTP/RTCP) to transmit at least one media packet associated with the VoIP communication session between users. That is, the selector 310 may generate the media channel candidates by combining the media address list (e.g., network addresses, IP addresses, etc., corresponding to the possible media relay server candidates capable of establishing the VoIP communication session and/or being used in the VoIP communication session between the at least two electronic devices).

In operation 5430, the estimator 320 may sequentially compare media channel candidates with a current media channel, may set one of the media channel candidates as a temporary media channel, and may estimate network performance of the VoIP session using the temporary media channel. By comparing and estimating only two paths, for example, the current media channel and the temporary media channel, instead of simultaneously comparing a plurality of media path clients, it is possible to reduce the network overhead of a client. Here, the candidate generation and estimation may be performed by applying a relay and a P2P network on the same line. The estimator 320 may transmit a probe packet during a desired period of time and may calculate at least one network metric, that is, at least one network factor, for example, a round trip time (RTT), a delay variance such as a jitter variance, a packet loss, and/or a bandwidth, etc., and may predict VoIP session quality (e.g., VoIP call quality, video chat quality, etc.) based on such metrics. A weight may be assigned to each metric. A metric and a weight used to predict the VoIP quality may be set to be different based on the media stream (e.g., media stream type) and/or a network environment. For example, the bandwidth may be used as a relatively important measurement standard for high definition (HD) video communication media stream sessions compared to other metrics, but may be a relatively less important measurement standard for audio-only communication media stream sessions, etc. The estimator 320 may estimate each pair of the current media path and the temporary media path by sequentially selecting a subsequent temporary media channel through an iterative process. According to at least one example embodiment, the estimator 320 may sequentially generate only a single media channel among the media channel candidates and, at the same time, may estimate the generated media channel with the current media channel, but the example embodiments are not limited thereto. Estimating a plurality of alternative media paths in real time may be inappropriate due to the amount of resource overhead levels (e.g., resources consumed by the estimation of alternative media paths). Thus, quality of a corresponding path may be measured by generating only a single temporary media path at a time based on the resource overhead and/or amount of resources consumed by the media path estimation.

In operation S440, the selector 310 may convert, to the current media channel, the temporary media channel that is predicted to enhance the VoIP quality based on a result of estimating the network performance. Accordingly, if an alternative media path exhibiting a further excellent and/or improved network performance compared to that of the current media channel is found, the selector 310 may replace the current media channel with the found alternative media path, thereby enhancing the VoIP quality.

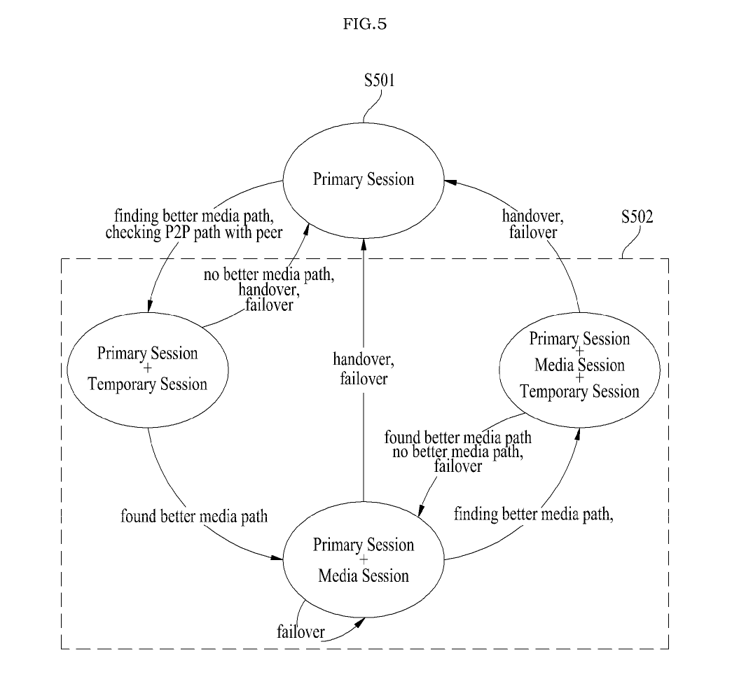

FIG. 5 illustrates an example of a procedure of searching for an improved and/or optimal network path for media transmission according to at least one example embodiment.

Referring to FIG. 5, the processor 222 uses a primary media channel (e.g., primary session) set as a default in operation S501 and performs an improved and/or optimal media channel selection process S502 for a fast call connection between users. Although another media channel is used instead of using the primary media channel, the primary media channel is maintained. In the improved and/or optimal media channel selection process S502, the processor 222 generates a media channel candidate by receiving a media address list from a media relay server and by combining the media address list. The processor 222 sets a single media channel among the media channel candidates as a temporary media channel (e.g., temporary session), estimates a network performance of the corresponding media channel, and performs a channel conversion to the corresponding media channel when the network performance of the temporary media channel is better than the current media channel. The above process is sequentially iterated based on the number of media channels available. Here, to decrease and/or minimize a network change effect of a client over time, the processor 222 selects an improved and/or optimal media channel by performing a relative comparison on an effect of an access network, for example, a network metric, at the same time. That is, the processor 222 measures and compares the network metric only with respect to the temporary media path and the current media path.

If a large number of media channel candidates are present, it may take a relatively long period of time to select the improved and/or optimal media channel. Accordingly, the processor 222 may reduce an amount of time by statistically or locally adjusting the order in which the media channel candidates are measured. For example, the processor 222 may store an improved and/or optimal media channel previously selected for the same counterpart in a local cache and may preferentially adjust the order in which the corresponding media channel is estimated. If a network performance is significantly poor at an initial stage of the improved and/or optimal media channel selection process S502, a test may be reduced (e.g., the number of tests performed may be reduced and/or the number of metrics tested for may be reduced, etc.).

Once a media transmission environment varies due to a network handover and the like during the improved and/or optimal media channel selection process S502, the processor 222 converts to the primary media channel set as the default.

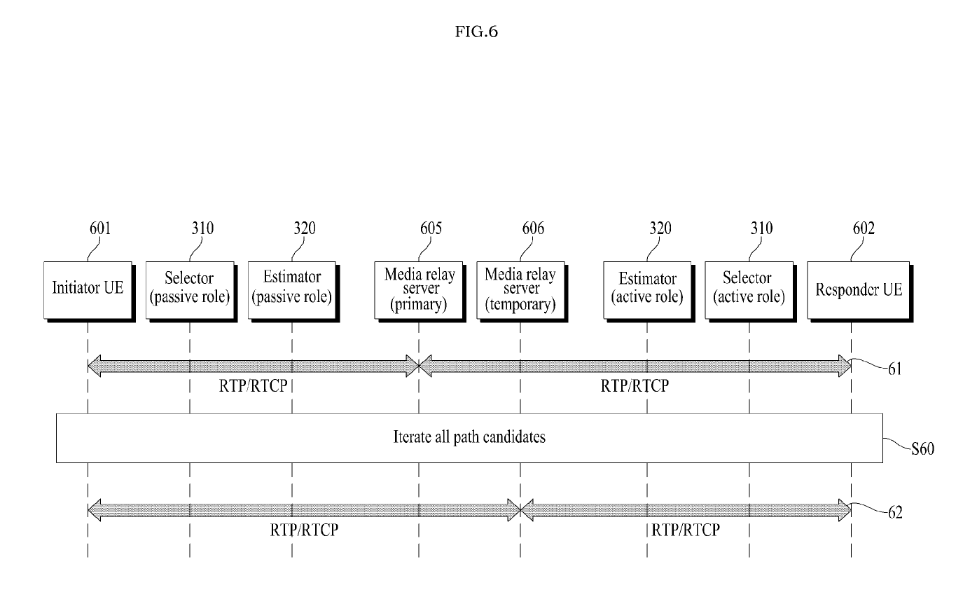

FIG. 6 illustrates an example of a media channel search process according to at least one example embodiment.

Referring to FIG. 6, for a call connection between a first electronic device, that is, an initiator user equipment (UE) 601 requesting communication at an early stage of the call connection process, and a second electronic device, that is, a responder UE 602 responding to the communication request from the initiator UE 601, the at least one processor 222 uses a primary media channel (e.g., primary session) 61 set as a default and established with a media relay server 605 and then performs an improved and/or optimal media channel section process S60. In the improved and/or optimal media channel selection process S60, when a network performance metric (e.g., condition, value, etc.), for example, VoIP quality, etc., of a temporary media channel (e.g., temporary session) 62 established with another media relay server 606 as one of media channel candidates is estimated to be better than that of the primary media channel 61, the at least one processor 222 converts a communication connection session between the initiator UE 601 and the responder UE 602 to the temporary media channel 62 having a relatively excellent and/or improved network performance. Here, although the temporary media channel 62 is used for communication connection between the initiator UE 601 and the responder UE 602 instead of the primary media channel 61, the primary media channel 61 may be maintained. When a communication environment varies due to a network handover, the corresponding media channel (e.g., the original media channel) may be converted to the primary media channel 61 again.

The at least one processor 222 may include the selector 310 and the estimator 320 to select the improved and/or optimal media channel, but the example embodiments are not limited thereto. The estimator 320 refers to a key module configured to measure and compare the network performance and is classified into an active role estimator and a passive role estimator. The active role estimator may calculate a network performance matrix and the passive role estimator may respond to a probe command from the active role estimator. The active role estimator may use the probe command to estimate the network performance and may perform a network performance test using a response of the passive role estimator to the probe command.

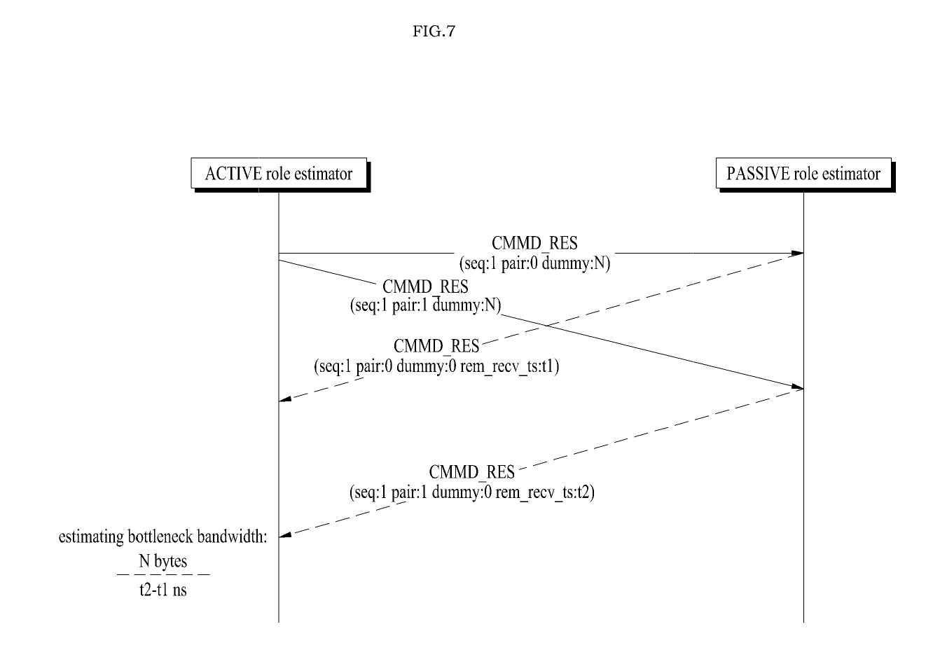

FIGS. 7 through 9 illustrate examples of a process of calculating a network metric according to at least one example embodiment.

An active role estimator may calculate a packet loss metric using a sequence number. For example, a timestamp field of a probe data structure is used as a measurement value, such as an RFT value, a delay value, etc. A combination of other probe data structure values, such as seq, pair, dummy_bytes, and/or rem_recv_ts, etc., may be used to estimate a bandwidth of a packet pair.

Referring to FIG. 7, the passive role estimator may transfer a response (e.g., CMMD_RES) excluding dummy_bytes in response to receiving a probe command from the active role estimator, and accordingly, the active role estimator may calculate a network performance metric using the response (e.g., CMMD_RES) of the passive role estimator. However, the example embodiments are not limited thereto.

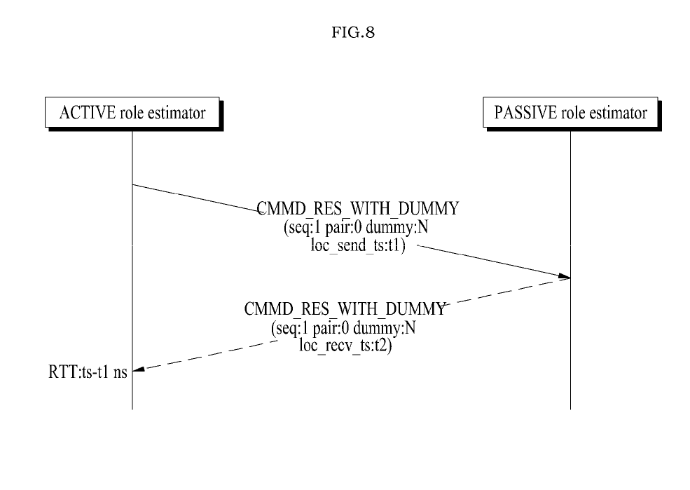

As another example, referring to FIG. 8, the passive role estimator may transfer a response (e.g., CMMD_RES_WITH_DUMMY) including dummy_bytes in response to a probe command from the active role estimator, and accordingly, the active role estimator may calculate a network performance metric using the response (e.g., CMMD_RES_WITH_DUMMY) of the passive role estimator.

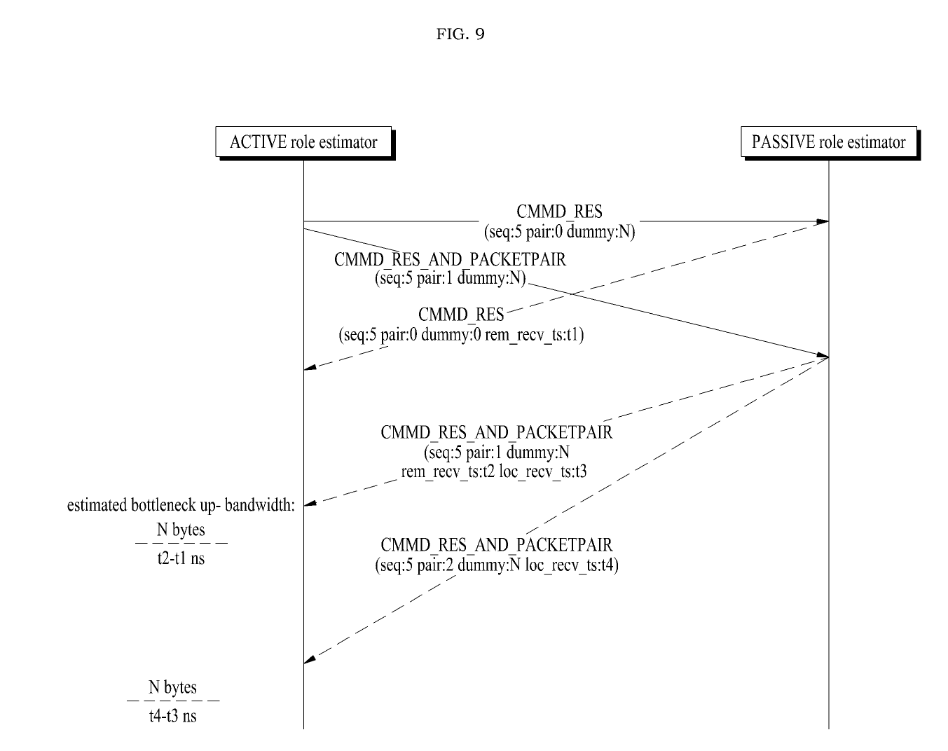

As another example, referring to FIG. 9, in response to receiving a probe command from the active role estimator, the passive role estimator sequentially responds with two packets. For example, a first packet may be the same packet “res_with_dummy”, but is not limited thereto. The packet may be transmitted once more immediately after transmitting the first packet. A difference between a time interval in which the packets are transmitted from the active role estimator corresponding to a transmission node and a time interval in which the packets are received at the passive role estimator corresponding to a reception node may be verified from the consecutive two packets. Such a mechanism is used to estimate a packet pair bandwidth as the network performance.

The selector 310 refers to a module configured to perform an improved and/or optimal media channel selection process with the estimator 320 and is classified into an active role selector and a passive role selector. The passive role selector may support a media channel search of the active role selector. The active role selector may generate a media channel candidate, and may determine whether to convert to a media channel having a relatively excellent (e.g., an improved) network performance based on the network performance estimated by the estimator 320.

A role of the active role selector is assigned to one of the initiator UE 601 and the responder UE 602 and a role of the passive role selector is assigned to the other UE. For example, the initiator UE 601 includes an instance of the passive role selector and the responder UE 602 includes an instance of the active role selector, but the example embodiments are not limited thereto. The responder UE 602 may fetch a media address list from the media relay server based on the instance of the active role selector and may generate the media channel candidate.

The active role selector may generate a media channel candidate. Here, the active role selector may include an address list of media relay servers and a P2P media path. That is, the active role selector may generate the media channel candidate by combining candidate addresses including a relay and a P2P network, etc.

The active role selector may designate an order priority for the media channel candidates. For example, the active role selector may determine the order priority based on the location information of the initiator UE 601 and the responder UE 602, history information of an improved and/or optimal media channel previously selected between the initiator UE 601 and the responder UE 602, a media stream, a network environment, and the like. A relay policy for generating the media channel candidate may include a combinable policy with another media relay server and/or a standalone policy incapable of relaying through the other media relay server. A weight may be used to determine a channel conversion and, herein, may be used to estimate the network performance.

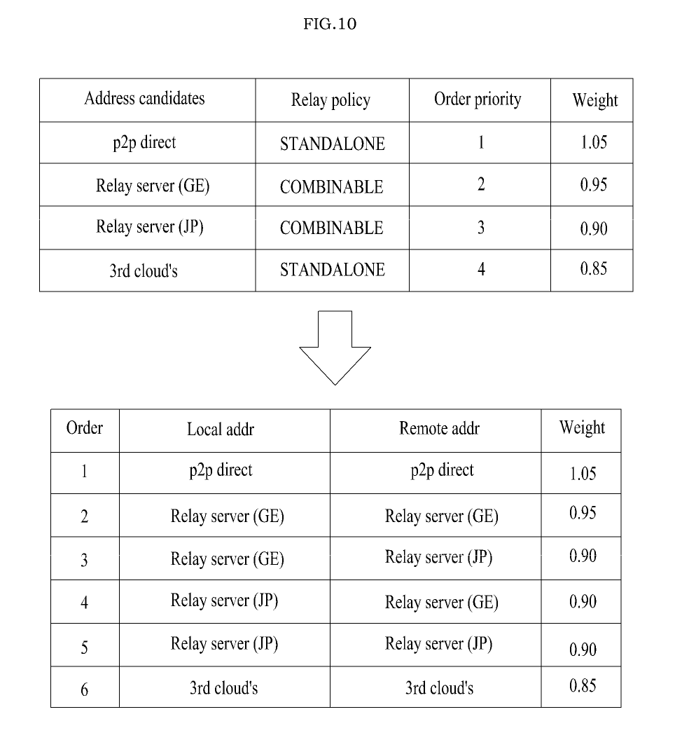

For example, referring to FIG. 10, the active role selector fetches an address list 1010 of media relay servers available for media transmission between the initiator UE 601 and the responder UE 602 and generates an address combination 1020 including, for example, two media relay servers by referring to the address list 1010. The address list 1010 may include all of the media available for the media transmission, and may include P2P and a 3^{rd} party cloud using a media relay server, however the example embodiments are not limited thereto. Here, the address combination 1020 is generated based on the combinable policy and the standalone policy and a combination of other addresses included in the standalone policy is removed, but the example embodiments are not limited thereto.

The estimator 320 may sequentially compare a network performance metric per two paths (e.g., the current media channel and a temporary media channel, etc.) based on the address combination 1020 generated by the selector 310, thereby decreasing and/or minimizing network overhead of a client and selecting an improved and/or optimal media channel in an environment in which a network change effect of the client over time is decreased and/or minimized.

The systems and/or apparatuses described herein may be implemented using hardware components, software components, or a combination thereof. For example, a processing device may be implemented using for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to the example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments, or vice versa.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variances are not to be regarded as a departure from the disclosure, and all such modifications are intended to be included within the scope of the disclosure.

What is claimed is:

1. A method implemented by a computer system, the method comprising:
generating, by one or more processors of the computer system, a plurality of media channel candidate capable of performing a media transmission between users in a voice over Internet protocol (VoIP) communication session;
setting, by the one or more processors, one of the plurality of media channel candidates as a temporary media channel;
estimating, by the one or more processors, network performance of the temporary media channel; and
changing, by the one or more processors, a current media channel of the VoIP communication session to the temporary media channel based on a result of estimating the network performance of the temporary media channel, and
the estimating and the changing is sequentially iterated with respect to each a plurality of media channels corresponding to the plurality of media channel candidates.

2. The method of claim 1, wherein the generating comprises generating the plurality of media channel candidates by combining an address list of a plurality of media relay servers capable of performing the media transmission.

3. The method of claim 2, wherein the generating comprises generating the plurality of media channel candidates by further including at least one of peer-to-peer (P2P) media service and a 3^{rd} party cloud service using the media relay server.

4. The method of claim 1, wherein the estimating comprises simultaneously estimating the network performance of the temporary media channel and comparing the network performance of the temporary media channel to network performance of the current media channel.

5. The method of claim 1, wherein the estimating comprises:
transmitting a probe packet through the temporary media channel; and
calculating at least one network metric using a response to the probe packet, the at least one network metric including at least one of a round trip time (RTT), a delay variance, a packet loss, and a bandwidth.

6. The method of claim 5, the calculating the at least one network metric comprising:
applying a different weight to each of the at least one network metric based on at least one of a media stream type and a network environment.

7. The method of claim 1, wherein the estimating comprises:
adjusting a network performance estimation order for the plurality of media channel candidates based on location information of at least one of a user requesting the VoIP communication session and a user responding to the VoIP communication session request, and history information of a media channel previously selected between the users.

8. The method of claim 1, further comprising:
initially using, by the one or more processors, a primary media channel set as a default, as the media channel for the media transmission prior to the generating,
wherein the primary media channel is maintained in response to changing the primary media channel to the temporary media channel.

9. A non-transitory computer-readable medium storing computer readable instructions that, when executed by at least one processor, cause the at least one processor to perform the method of claim 1.

10. A computer system comprising:
one or more processors configured to execute non-transitory computer-readable instructions included in a memory to,
generate a plurality of media channel candidates capable of performing a media transmission between users in a voice over Internet protocol (VoIP) communication session;
set one of the plurality of media channel candidates as a temporary media channel;
estimate network performance of the temporary media channel; and
change a current media channel of the VoIP communication session to the temporary media channel based on a result of the estimating the network performance of the temporary media channel, and
the estimating and the changing are sequentially iterated with respect to each of a plurality of media channels corresponding to the plurality of media channel candidates.

11. The computer system of claim 10, wherein the generating the plurality of media channel candidates includes combining an address list of a plurality of media relay servers capable of performing the media transmission.

12. The computer system of claim 11, wherein the generating the plurality of media channel candidates by further including at least one of peer-to-peer (P2P) media service and a 3^{rd} party cloud service using the media relay server.

13. The computer system of claim 10, wherein the estimating includes simultaneously estimates the network performance of the temporary media channel and compares the network performance of the temporary media channel to network performance of the current media channel.

14. The computer system of claim 10, wherein the estimating includes:
transmitting a probe packet through the temporary media channel; and
calculating at least one network metric using a response to the probe packet, the at least one network metric including at least one of a round trip time (RTT), a delay variance, a packet loss, and a bandwidth.

15. The computer system of claim 14, wherein the one or more processors are further configured to:
apply a different weight to each of the at least one network metric based on at least one of a media stream type and a network environment.

16. The computer system of claim 10, wherein the estimating includes adjusting a network performance estimation order for the plurality of media channel candidates based on location information of at least one of a user requesting the VoIP communication session and a user responding to the VoIP communication session request, and history information of a media channel previously selected between the users.

17. The computer system of claim 10, wherein the one or more processors are further configured to initially use a primary media channel set as a default, as the media channel for the media transmission prior to the generating, and
the primary media channel is maintained in response to changing the primary media channel to the temporary media channel.
